(19) United States
(12) Patent Application Publication
(10) Pub. No.: US 2018/0183624 A1
(43) Pub. Date: Jun. 28, 2018

(54) Transmission of Telegrams Via a Shared Medium

(71) Applicant: Siemens Aktiengesellschaft, München (DE)

(72) Inventors: David COULON, Sindelfingen (DE); Martin HERBSTRITT, Renningen (DE); Albert KRENZ, Ehningen (DE); Klaus-Peter LINZMAIER, Winterbach (DE); Hicham NOURDDINE, Weil der Stadt (DE)

(73) Assignee: Siemens Aktiengesellschaft, Munchen (DE)

(21) Appl. No.: 15/737,692

(22) PCT Filed: Apr. 29, 2016
(86) PCT No.: PCT/EP2016/059670

§ 371 Date: Dec. 18, 2017

(30) Foreign Application Priority Data
Jun. 18, 2015 (DE) 10 2015 211 281.0

(51) Int. Cl. H04L 12/413

(52) U.S. Cl. CPC H04L 12/413; H04L 2012/4026

(57) ABSTRACT

A method for transmitting telegrams via a shared medium (SHM) included in a network, in particular in an industrial contact wire network, wherein the network includes a control unit, a master level, the shared medium, a slave level, and end devices, where an access to the shared medium is respectively performed via master- and/or slave-side modems, where the control unit communicates with the end devices via the shared medium, where at least one master- and/or slave-side traffic manager provides telegrams to the master- and/or slave-side modems, and where in order to reduce the number of accesses to the shared medium, the master- and/or slave-side traffic managers have knowledge of the structure of relevant parts of the network, and compile the telegrams into groups of telegrams.

### CROSS-REFERENCE TO RELATED APPLICATIONS

This is a U.S. national stage of application No. PCT/EP2016/059670 filed 29 Apr. 2016 and claims the priority of German application No. 102015211281 filed Jun. 18, 2015, the content of which is incorporated herein by reference in its entirety.

### BACKGROUND OF THE INVENTION

### 1. Field of the Invention

The invention relates to a method, a network arrangement, a corresponding modem arrangement for transmitting telegrams via a shared medium and to an industrial conveying system in which the method is implemented.

### 2. Description of the Related Art

It is known to use methods, a network arrangement and corresponding modem arrangements, for instance, in a contact wire network in an industrial suspension track or also electric monorail systems (EMS). Further applications exist, for instance with rack feeders, ground conveyors, crane systems, rotary feedthroughs and turntables, elevators and hoisting equipment, transfer trolleys and fairground rides. Electric monorail systems consist of a stationary system control and power supply, the rail system and the mobile vehicles. The mobile vehicles are either connected to solid current bars, contact lines or contact rings by way of consumers, in particular sliders, or trailing cables are used to form the connection.

### SUMMARY OF THE INVENTION

It is an object of the invention to provide a method that reduces the number of accesses to a shared medium and to provide a network arrangement and a modem arrangement which are suitable for implementing the method.

These and other objects and advantages are achieved in accordance with the invention by a method in which telegrams are transmitted via a shared medium in a network, in particular in an industrial contact wire network. The network has a control device, a master level, the shared medium, a slave level and terminals, where an access to the shared medium is performed via master- and/or slave-side modems in each case, where the control device communicates with the terminals via the shared medium, where at least one master- and/or slave-side traffic manager provides telegrams to the master- and/or slave-side modems and where the master- and/or slave-side traffic managers each have knowledge of the structure of relevant parts of the network, and compile the telegrams into groups of telegrams.

The invention is based on the knowledge that the number of accesses to the shared medium can be reduced if the master- and/or slave-side traffic managers have knowledge of the structure of relevant parts of the network and compile the telegrams into groups of telegrams.

Here, the master level is considered to be an organizational level that is disposed on the side of the control devices. It must, however, not be ruled out that terminals are also arranged in the master level. Analogously, the slave level is the area in which the terminals are arranged. The shared medium connects the devices of the master level with the devices of the slave level. The shared medium is a network connection, not in the sense of a conventional, “switched network”, such as a switched Ethernet, but instead generally in the sense of a communication medium used by a number of communication partners. In such cases, the shared medium may be a contact wire network, a powerline network or a radio network, for instance. In a contact wire network, a number of subscribers communicate via a network of contact wires. The shared medium can therefore be a line and/or cable-bound network, the subscribers of which are movably supported at least partially with respect to the network itself. In such cases, the control device is very generally considered to be a controller or control function for the terminals and possibly further devices. This involves, for instance, an industrial controller, which sends control commands to terminals, such as engine controls or sensor arrangements, or receives measured values herefrom. Any devices that communicate with one another can and are to do this via the shared medium. For instance, with a suspension track, which is controlled via a contact wire network in the sense of a shared medium, a control device could be a central control facility that supplies the vehicles on the suspension track with their movement profiles. A number of terminals can be arranged in such a vehicle. Similarly, it is possible for each of these vehicles to have a number of modems. For instance, in the case of an EMS system the control device coordinates the vehicles located there and provides target coordinates and speeds. The automation logic of the EMS system is stored on the control device, for instance. The control device implements the automation logic, controls the vehicles and prevents mechanical collisions. The automation logic can also permit manual intervention by way of HMI terminals.

A modem is a device that permits access to the shared medium. The modems are therefore the interface between the shared medium and the remaining network. If a modem now accesses the shared medium through an access, the shared medium is therefore blocked for other modems at least during this access and in a specific range of the modem. If, however, another modem is to send telegrams and/or data simultaneously, this may result in a collision of telegrams. It is therefore important, as far as possible during access to the shared medium, only to send the telegrams and/or data that are required and at the same time as much data as possible in this period of time. To realize this, a traffic manager has knowledge of the structure of relevant parts of the network and compiles telegrams into groups of telegrams.

Here, relevant parts of the network can be the superordinate or subordinate parts of the network that are assigned to the respective traffic manager. In such cases, the reachable modems and the reachable terminals are of particular importance. Whether a part of the network is relevant depends heavily on the actual topology of the network and of the shared medium.

The traffic manager can be a dedicated controller, for instance. The traffic manager can, however, likewise be tasks on a system, for instance, which is already used to control the modem. The master-side traffic managers differ from the slave-side traffic managers only in as much as a master-side is expected to have more telegrams, in other words overall a greater data throughput. Irrespective of this, it is not to be ruled out that in certain situations and areas of the network, more telegrams temporarily or even durably accumulate on the slave side than on the master side.

On account of the potentially large physical extent of the shared medium, not all master-side modems reach all slave-side modems. It can instead be assumed that master-side modems only reach the slave-side modems assigned thereto. The traffic managers can be integrated into the control device and also into the master modems, for instance.

The traffic managers therefore permit optimal utilization of the limited capacities of the shared medium. This is possible in an easy and efficient manner by grouping the telegrams. It is particularly advantageous if the maximum number of subscribers of a shared medium can be easily and efficiently increased by compiling telegrams into groups of telegrams. Therefore, without additional hardware outlay the number of subscribers can be increased or with a constant number of subscribers, a less powerful and subsequently more cost-effective infrastructure can be selected.

It is generally assumed that the grouping of telegrams brings advantages above all in the direction of the terminals, in other words away from the control device, because here the expected traffic, in other words the number of telegrams, is correspondingly large. However, it cannot be ruled out that useful grouping options also exist away from the terminal in the direction of the control device. For instance, this may be the case if a particularly large number of terminals can be reached via a slave-side modem and in specific cases these report back a large amount of data to the control device.

In a particularly advantageous embodiment of the inventive method, the traffic manager forms the groups of telegrams based on the knowledge of the structure of relevant parts of the network. The traffic manager therefore draws on the knowledge of the structure of relevant parts of the network to form the groups of telegrams. The structure information therefore advantageously influences the groups, the telegrams can be delivered more efficiently, and the network is operated at optimal capacity.

In a further advantageous embodiment, the traffic manager forms the groups of telegrams based on information relating to the modems and/or terminals that can be reached via the respective traffic manager. The information relating to the modems that can be reached via the respective traffic manager now directly influences the formation of the groups. This is advantageous in that the groups that were formed in this way can be distributed more efficiently and the utilization of the network can be increased again.

In a further advantageous embodiment, the traffic manager only compiles those telegrams into groups of telegrams, which are specific to modems and/or terminals and which can be reached via the respective traffic manager. This may be advantageous if a large part of the telegrams are to be delivered solely to individual terminals and only few or no telegrams are to be delivered to all subscribers of the network. Furthermore, with this type of grouping, the right of access of the modem to the shared medium can also be awarded. This is advantageous in that not only more subscribers are supplied via the shared medium, but collisions are also avoided by the access control and determinism can be guaranteed.

In a further embodiment, at least one modem manager controls and/or reads out the modems. Here, a modem manager is a component that performs settings on a modem that is suitable for access to the shared medium. These settings include inter alia the selection of the function, i.e., whether a master or a slave modem is present. Furthermore, particularly with line-bound shared media such as contact wire networks, an amplitude map for modulation and limit values can be used for the modem-internal amplifier stages. Furthermore, the modem manager can read out information, such as a tone map, i.e., how many bits per carrier can be encoded or the current and potentially the preceding connecting status. If this is a master modem, then a subscriber list or a topology, for instance, which modems and/or which subscribers can be reached behind which modem, can be read out. To this end, the addressees of the telegrams and/or the payload could be evaluated, for instance.

In a further embodiment, the master- and/or slave-side traffic manager obtains the knowledge of the structure of relevant parts of the network at least partially from a master- and/or slave-side modem manager. The modem managers could, in this case, create corresponding lists by evaluating the addressees of the telegrams to determine which components can be reached by way of the modems assigned to the modem manager. The traffic manager then obtains in turn corresponding lists from the modem manager, and can thus use this information relating to the topology to form groups. This is particularly effective because the traffic manager does not itself not need to learn the topology information, but instead receives this topology information from the modem managers. The traffic manager can therefore make full use of the computing time available to it to group telegrams. However, it cannot be ruled out that traffic managers and modem managers are realized in one component. It is likewise conceivable for the traffic manager to obtain its structure information exclusively from a modem manager. However, it is also likewise possible for the traffic manager to already receive notification at least of parts of the structure during commissioning of the system.

In a further embodiment, the master- and/or slave-side traffic manager for each access to the shared medium describes which groups of telegrams are sent with this access. In principle, it should apply that the modem that has current access to the shared medium and thus claims the shared medium for itself, sends as many telegrams as possible in the predetermined time. In such cases, the predetermined time can be a fixed time period or also simply merely the stipulation to terminate the transmission as quickly as possible and thus to release the shared medium again. The traffic manager can advantageously intervene here by deciding which groups of telegrams absolutely have to be sent with the next access to the shared medium and which groups of telegrams can still be retained. This results in a more efficient processing of the individual groups and thus in a higher capacity of the shared medium, because the shared medium is not blocked with the transmission of groups of telegrams, which as yet do not have to be sent at the current point in time. If the shared medium is based on a transmission of what are known as symbols, it is therefore conceivable for a correspondingly large group to be split into a number of consecutive symbols. It is likewise possible to transmit a number of groups using a number of consecutive symbols.

In a further advantageous embodiment, the traffic manager uses priority levels to form the groups of telegrams. Here, priority levels can be of a temporal or causal nature, for instance. On the one hand, telegrams that have already experienced a long transmission time can be assigned a higher priority level. On the other hand, telegrams that ideally have to be sent immediately, such as emergency off signals, can likewise be provided with a higher or the highest priority level. This is advantageous in that despite optimal utilization of the shared medium, important telegrams arrive reliably and deterministically at the correct receiver. In such cases, the priority levels could be contained directly in the header information of the telegrams, for instance, they could however also be stored in the traffic manager for certain types of telegrams or calculated there from the elapsed time, for instance.

The compromise between optimal utilization of the shared medium and the avoidance of impermissibly high transmission times can also be achieved by the traffic manager obtaining knowledge about the requirements on the permissible transmission time for the individual telegrams or groups. On the basis of the requirements on the permissible transmission time, the traffic managers are then able to select the waiting time for suitable telegrams such that the requirements with respect to the transmission time are not violated. This assumes that aside from the knowledge of the structure of relevant parts of the network, the traffic managers also know the requirements on the tolerable transmission time for each relevant structure element. It is to be assumed, for instance, that a terminal, which is to receive telegrams from the control device every 128 ms, for instance, also still accepts telegrams if the transmission lasts for longer than 128 ms. In PROFINET standard settings, the duration can even amount to up to 256 ms, if the cycle time lies at 128 ms. In an optimized embodiment, the permissible transmission time can be individually set for each relevant terminal.

Based on the structure, the traffic manager is accordingly additionally able, for each element, such as master-/slave-side modem and terminals connected hereto, which can be reached thereby or via its modem, to determine how often these have to be supplied with data or how often these provide data. The described sequence of communication must then not take place cyclically in accordance with the list of known receivers, but could be processed to suit requirements. For instance, all telegrams are then always transmitted to the modem if one of the terminals, the traffic or the modem manager, must at the latest be supplied with data. A response may also only then be required if the telegrams to be transmitted in the opposite direction cannot wait until the next cycle.

In a further embodiment, a protocol for avoiding collisions during the transmission of telegrams is used to avoid collisions in the shared medium. Protocols of this type can be, for instance, CSMA/CA, CSMA/CD or tokens as well as combinations or related methods. The inventive method allows telegrams to be sent more efficiently to their receivers. The possibility that two modems simultaneously access the shared medium and thus cause a collision was not taken into account, here. With smaller systems, collision avoidance can be achieved by correspondingly generously designing the communication bandwidth. With systems or networks with a number of subscribers, it is advantageous, however, to use a protocol for collision avoidance. Therefore, the inventive method is more reliable and the number of subscribers can be increased still further while retaining the same hardware and costs. In such cases, the slave and also the master traffic manager could also use collision-avoiding methods. For instance, one of the CSMA methods can be used as a lower-level method for collision avoidance. A master-slave method can then in turn form the basis of the first method for collision avoidance and thus be combined. For instance, a master sends at least one telegram to a slave and this then, for its part, sends at least one telegram back to the master. Only one network component (master or slave) thus attempts to access the medium at each time point and this cannot result in collisions.

It is also an object of the invention to provide a network arrangement for transmitting telegrams via a shared medium in a network in accordance with the inventive method, where the network arrangement has a control device, a master level, a shared medium, a slave level and terminals, each of which has at least one master- and one slave-side modem and at least one master- and one slave-side traffic manager. The central element of this network arrangement is the shared medium. The shared medium can, as already mentioned in the introduction, be a contact wire network, where the terminals are movable relative to the shared medium. Using the inventive method it is possible for this network arrangement to manage and operate more subscribers.

In a further embodiment, the shared medium is a cable- and/or line-bound medium with movable contacts, in particular contact wires. Here, a cable- and/or line-bound medium stands for a data transmission via any cable/line, with one or a number of strands, which are at least theoretically suitable for transmitting data and/or electric power. Here, the cables and/or lines of the contact wire network can have a carrier voltage, in particular a carrier alternating voltage of nominally +/−42V. It is likewise conceivable for a current, for supplying third-party devices, to flow via the cable/lines in addition to the data signal.

It is also an object of the invention to provide a modem arrangement for implementing the inventive method, where the modem arrangement has at least one modem and one traffic manager. This modem arrangement can be stationary or movable depending on the level used, i.e., whether in the master or the slave level. If, for instance, modems are arranged in the slave level, they could move via a contact wire relative to the shared medium. Here, the modem arrangement is formed such that it permits access to the shared medium. For instance, this can be corresponding network interfaces, which modulate a signal up to a cable or a line. The traffic manager need not necessarily be arranged physically on the modem itself, but can also be connected thereto via a further network connection. Naturally, one possibility is also conceivable, in which the traffic manager is integrated into a computer unit of the modem or is attached or connected directly to the modem.

In a further embodiment, the modem arrangement has a modem manager. This is then particularly advantageous if the traffic manager acquires the knowledge of relevant parts of the network from the modem manager.

The inventive method is used particularly advantageously in an industrial conveying system. Particularly with suspension track systems, the terminals of which are connected to the shared medium by way of contact wires, this method is advantageous because the number of vehicles can thus be increased.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described and explained in more detail below with the aid of the exemplary embodiments shown in the figures, in which:

FIG. 1 shows a network arrangement, having a shared medium in accordance with the invention;

FIG. 2 shows a modem arrangement in a functional representation in accordance with the invention;

FIG. 3 shows a modem arrangement in a basic, physical representation in accordance with the invention;

FIG. 4 shows a representation of the accesses of several modems to the shared medium in accordance with the invention;

FIG. 5 shows an exemplary representation of the grouping and transmission of telegrams via the shared medium; and

FIG. 6 is a flowchart of method in accordance with the invention.

### DETAILED DESCRIPTION OF THE EXEMPLARY EMBODIMENTS

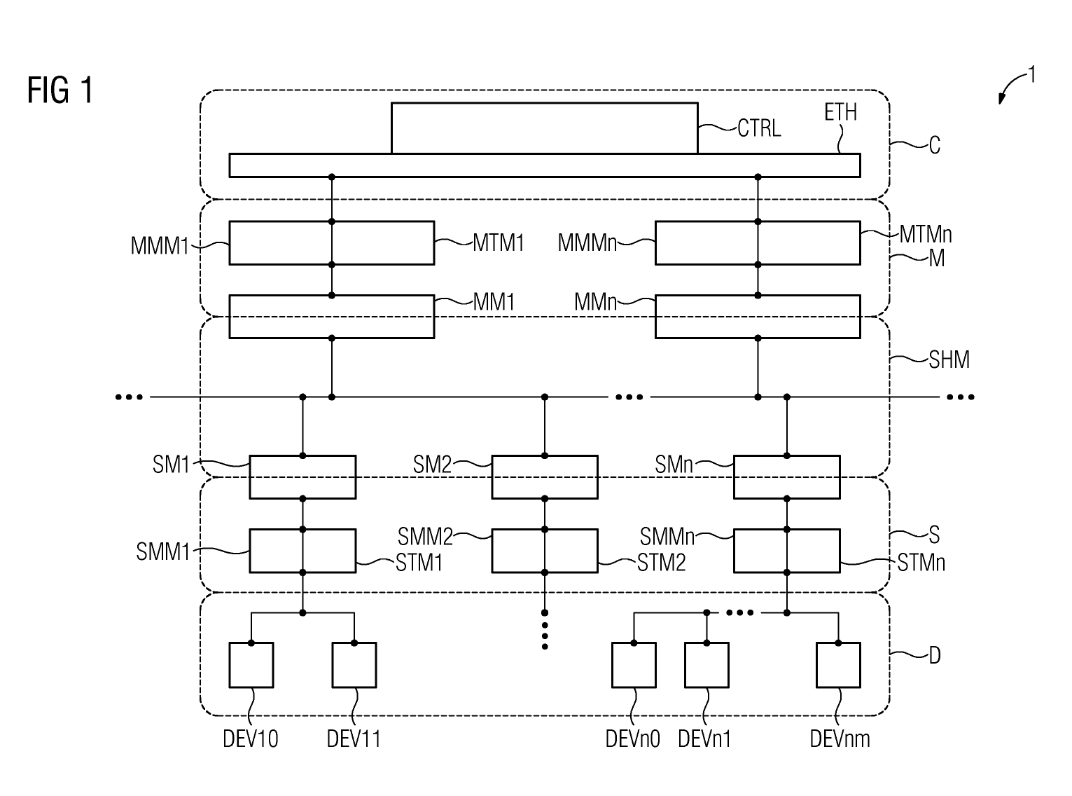

FIG. 1 shows a network arrangement in the form of a network 1. Here, the network 1 has a control level C, a master level M, a shared medium SHM, a slave level S and a device level D. This means that, where logically and functionally useful, the master level M can contain the control level C and the slave level S can contain the device level D. It is likewise conceivable for further levels to be integrated into others or for further interstitial levels that assume further functions to be inserted. A control device CTRL and an Ethernet connection ETH are disposed in the control level C. The Ethernet connection ETH connects the control device CTRL firstly to the master level M. The master level M contains master modem managers MMM1, . . . , MMMn and master traffic managers MTM1, . . . , MTMn. The interface between the master level M and the shared medium SHM is formed by master modems MM1, . . . , MMn. Similarly bound to the shared medium SHM are the slave modems SM1, . . . , SMn that serve as an interface to the slave level S. The slave level S has slave modem managers SMM1, . . . , SMMn and slave traffic managers STM1, . . . , STMn. The device level D has terminals DEV10, . . . , DEVnm.

If the divided medium SHM is a contact wire of an electric monorail system for instance, then the control device CTRL would be as a central automation logic. The Ethernet ETH would then also supply the master modems MM1, . . . , MMn via their master traffic managers MTM1, . . . , MTMn and/or their master modem managers MMM1, . . . , MMMn with telegrams, which can be control commands of the control device CTRL, for instance. Here, the shared medium SHM could have sliding contacts, and the slave modems SM1, . . . , SMn would therefore be moveable with respect to the shared medium SHM. The Ethernet connection ETH can be any data connection. A WLAN is therefore likewise conceivable in addition to a conventional LAN.

The shared medium SHM has two areas in FIG. 1. The left area, which can be reached via master modem MM1, contains the slave modem SM1 and the slave modem SM2. The right area, which can be reached via master modem MMn, contains the slave modem SMn. Here the three points between the left and the right area symbolize that the master modem MM1 cannot automatically reach the slave modem SMn and analogously the master modem MMn cannot automatically reach the slave modems SM1 and SM2. It should, instead, be assumed that the master modem MM1 only reaches the slave modems SM1 and SM2 assigned thereto and the master modem MMn only reaches the slave modem SMn assigned thereto. Therefore, by using the inventive method, the master traffic manager MTM1 could group telegrams, which are specific to one of the terminals DEV10 or DEV11, accordingly and send the same via the shared medium SHM to the slave modem SM1. Analogously, this applies to terminals that can be reached via the slave modem SM2, and which are only indicated in FIG. 1 by way of three points.

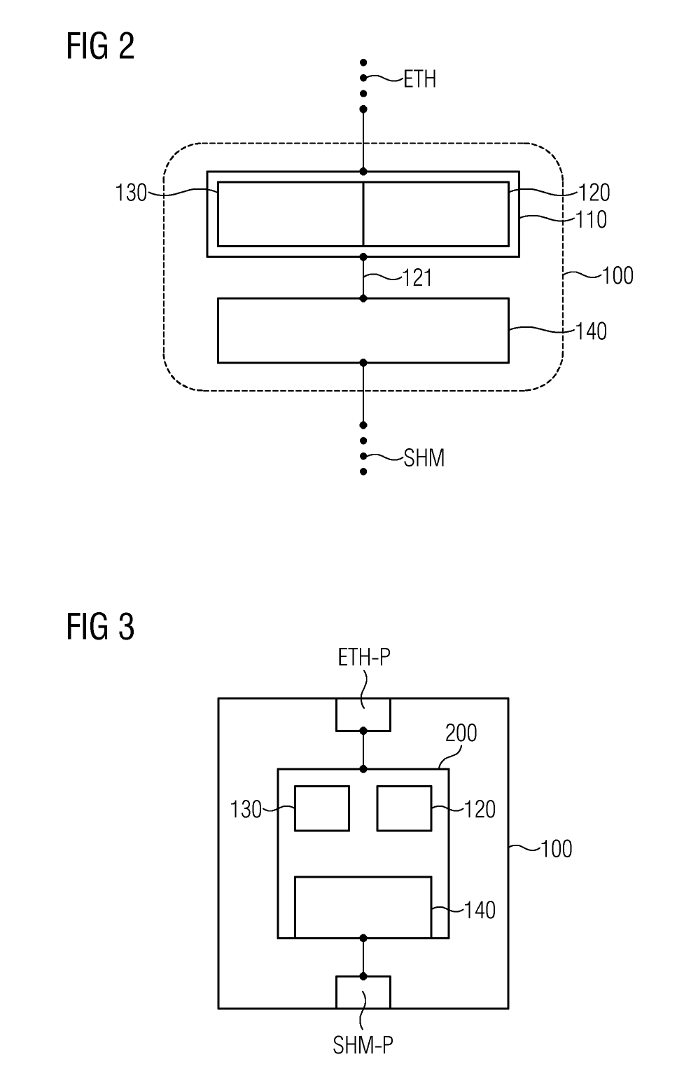

FIG. 2 shows a modem arrangement 100, which has a traffic manager 120 and a modem manager 130. Here, a management arrangement 110 comprises the traffic manager 120 and the modem manager 130. The management arrangement 110 is connected to a modem 140 via an internal connection 121. On the one hand the modem arrangement 100 produces a connection in the direction of the shared medium SHM and above, on the other hand, a connection in the direction of the Ethernet ETH. The arrangement shown is intended to represent how an arrangement could in principle look in terms of performing the inventive method. Here, the connection in the direction of the Ethernet ETH could be formed as a LAN or as a WLAN. The connection in the direction of the shared medium could be formed here as a contact wire. Here, the management arrangement 110 could be a Linux system, on which in each case a task runs for the modem manager 130 and the traffic manager 120. The tasks can be formed here advantageously for parallel execution.

By retaining the reference signs from FIG. 2, FIG. 3 shows a modem arrangement 100 that has a modem processor unit 200. Here, the modem processor unit 200 contains the actual modem 140, the traffic manager 120 and the modem manager 130. It is conceivable here that the modem manager 130 and the traffic manager 120 are realized as a system-on-a-chip (SOC). The modem 140 represents the physical interface in order to be able to access the shared medium. Furthermore, an Ethernet port ETH-P and a port for accessing the shared medium SHM-P are shown. The Ethernet port ETH-P can be an RJ45 socket, for instance. Depending on the shared medium used, screw, plug-in, clamping or corresponding further connections are conceivable for the port for access to the shared medium SHM-P. The modem processor unit 200 shown is intended only to represent an exemplary embodiment. It is likewise conceivable that individual components of the modem arrangement 100 are realized at other points in the network or in other devices.

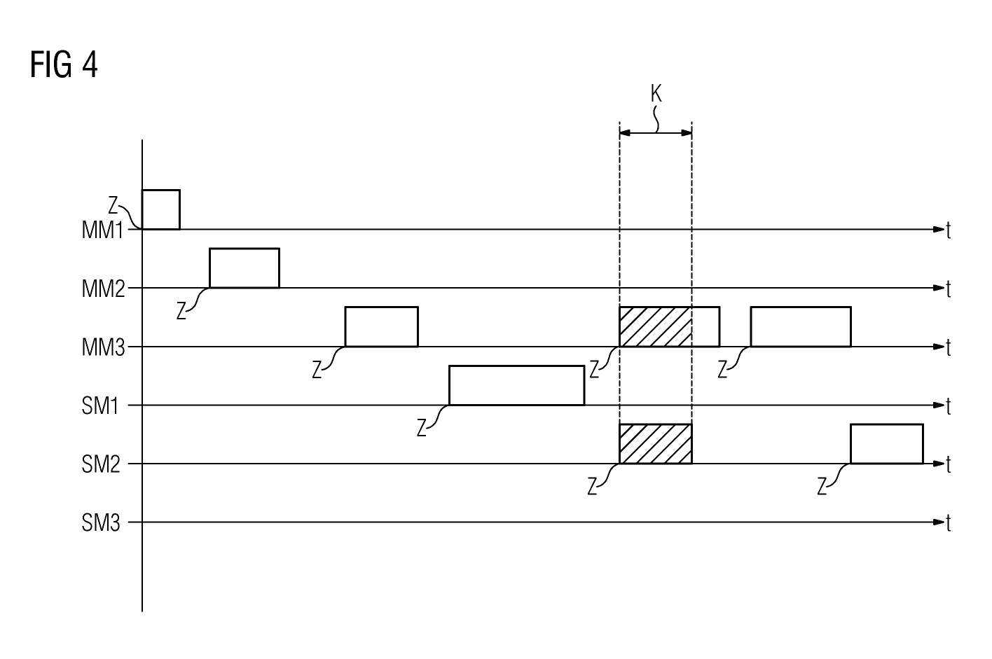

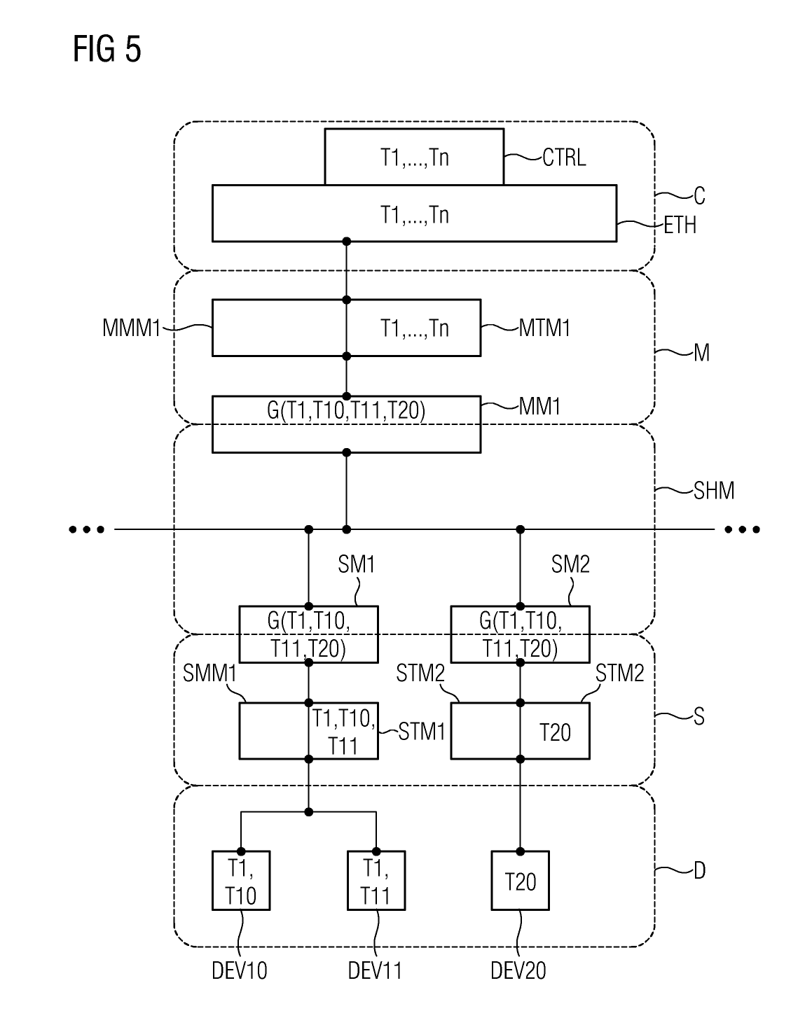

By way of example, FIG. 4 shows the access course over time t of three master modems MM1, MM2 and MM3 and three slave modems SM1, SM2 and SM3 to the shared medium SHM. If one of the modems accesses the shared medium SHM, this is characterized by an access Z with a length that corresponds to the duration of the access Z. During the access Z, telegrams can be transmitted via the shared medium SHM. Firstly, the master modem MM1 accesses the shared medium SHM. Accesses Z by the master modem MM2 and the master modem MM3 follow on consecutively within a short period of time. The access Z of the slave modem SM1 has a longer duration than all other accesses Z. Once the slave modem SM1 has concluded its access, the master modem MM3 and the slave modem SM2 simultaneously access the divided medium. A collision K, which identifies the region in which both modems send at the same time, therefore exists. In this case, the slave modem SM2 concludes its access prior to the master modem MM3. It is conceivable that telegrams could not be successfully transferred during any of the two accesses Z. One possible procedure shown is that after a brief time the master modem MM3 repeats its access Z to the shared medium SHM and then also the slave modem SM2 can perform its access Z to the divided medium. In the area shown, the slave modem SM3 has not performed any access Z. During the accesses Z, both individual telegrams and also groups of telegrams can be transmitted. Collision-avoiding methods can be used in order to avoid collisions K.

FIG. 5. shows a cutout of a network. Here, the reference signs are largely analogous to FIG. 1. By way of example, this shows how telegrams T1, . . . , Tn, which are generated in this case in the control device CTRL, are forwarded via the Ethernet ETH to the master level M. The master traffic manager MTM1 contains all telegrams T1, . . . , Tn and can obtain the structure of the terminals DEV10, DEV11 and DEV20, which can be reached via the master modem MM1, from the master modem manager MMM1. The master traffic manager MTM1 extracts the telegrams, which are suitable for transmission via the master modem MM1. The master traffic manager MTM1 in this case compiles the telegrams T1, T10, T11 and T20 to form the group G. The group G is then sent from the master modem MM1 via the shared medium SHM to the two reachable slave modems SM1 and SM2. The slave traffic managers STM1 and STM2 contain the group G and extract telegrams therefrom that are specific to terminals DEV10, DEV11 and DEV20 that can be reached thereby. The slave traffic manager STM1 therefore extracts the telegrams T1, T10, and T11. The slave traffic manager STM2 only extracts the telegram T20 from the group G. In the further course, the slave traffic managers STM1 and STM2 send the respective telegrams to the terminals DEV10, DEV11 and DEV20. Here, it is conceivable that all telegrams are sent to all respectively reachable terminals DEV10, DEV11 and DEV20, or that the telegrams are repeatedly divided and only issued to the respective receiver. By way of example, FIG. 5 shows that the telegram T1 is relevant to both terminals DEV10 and DEV11 in each case. The telegrams T10 and T11 are each issued only to the terminal to which they are specific.

In summary, the disclosed embodiments of the invention relate to a method for transmitting telegrams T1, . . . , Tn via a shared medium SHM in a network 1, in particular in an industrial contact wire network, where the network 1 has a control device CTRL, a master level M, the shared medium SHM, a slave level S and terminals DEV10, . . . , DEVnm. Each access Z to the shared medium SHM is performed via master- and/or slave-side modems MM1, . . . , MMn; SM1, . . . , SMn, where the control device CTRL communicates with the terminals DEV10, . . . , DEVnm via the shared medium SHM, where at least one master- and/or slave-side traffic manager MTM1, . . . , MTMn; STM1, . . . , STMn makes telegrams T1, . . . , Tn available to the master- and/or slave-side modems MM1, . . . , MMn; SM1, . . . , SMn. To reduce the number of accesses Z to the shared medium SHM, the master- and/or slave-side traffic managers MTM1, . . . , MTMn; STM1, . . . , STMn have knowledge of the structure of relevant parts of the network and compile the telegrams T1, . . . , Tn into groups G of telegrams T1, . . . , Tn.

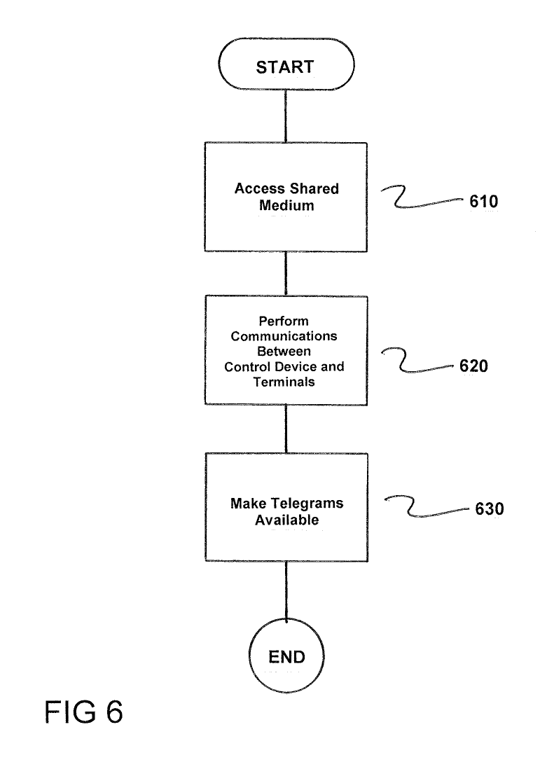

FIG. 6 is a flowchart of a method for transmitting telegrams T1, . . . , Tn via a shared medium SHM included in a network 1 having a control device CTRL, a master level M, a slave level S and terminals DEV10, . . . , DEVnm. The method comprises accessing Z the shared medium SHM via each of at least one of (i) master-side modems MM1, . . . , MMn and (ii) slave-side modems SM1, . . . , SMN, as indicated in step 610.

Next, communications between the control device CTRL and terminals DEV10, . . . , DEVnm via the shared medium SHM are performed, as indicated in step 620.

The telegrams T1, . . . , Tn are now made available to at least one of the (i) master-side modems MM1, . . . , MMn and (ii) slave-side modems SM1, . . . , SMn by at least one of (i) a master-side traffic manager MTM1, . . . , MTMn and (ii) a slave-side traffic manager STM1, . . . , STMn, as indicated in step 630.

In accordance with the method of the invention, master-side traffic managers MTM1, . . . , MTMn and/or slave-side traffic managers STM1, . . . , STMn have knowledge of the structure of relevant parts of the network 1 and compile the telegrams T1, . . . , Tn into groups G of telegrams T1, . . . , Tn.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for transmitting telegrams via a shared medium included in a network having a control device, a master level, a slave level and terminals, the method comprises:
accessing the shared medium via each of at least one of (i) master-side modems and (ii) slave-side modems;
performing communications between the control device and terminals via the shared medium;
creating availability of telegrams by at least one of (i) a master-side traffic manager and (ii) a slave-side traffic manager to at least one of the (i) master-side modems and (ii) slave-side modems;
wherein at least one of (i) master-side traffic managers and (ii) slave-side traffic managers have knowledge of structure of relevant parts of the network and compile the telegrams into groups of telegrams.

16. The method as claimed in claim 15, wherein at least one of the (i) master-side traffic manager and (ii) slave-side traffic manager forms the groups of telegrams based on the knowledge of the structure of relevant parts of the network.

17. The method as claimed in claim 15, wherein at least one of the (i) master-side traffic manager and (ii) slave-side traffic manager forms the groups of telegrams based on information with respect to the at least of the (i) master-side modems, (ii) slave-side modems and (ii) terminals which can be reached via a respective traffic manager.

18. The method as claimed in claim 15, wherein at least one of the (i) master-side traffic manager and (ii) slave-side traffic manager only compiles the telegrams into groups of telegrams, which are specific to at least one of (i) modems and (ii) terminals, which is reachable via a respective traffic manager.

19. The method as claimed in claim 15, wherein at least one of (i) at least one master-side modem manager and (ii) at least one slave-side modem manager at least one of (i) controls and (ii) reads out modems.

20. The method as claimed in claim 19, wherein at least one of the (i) master-side traffic manager and (ii) slave-side traffic manager obtains the knowledge of the structure of relevant parts of the network at least partially from at least one of a master-side modem and a slave-side modem manager.

21. The method as claimed in one claim 15, wherein for each access to the shared medium at least one of the (i) master-side traffic manager and (ii) slave-side traffic manager decides which groups of telegrams are sent with this access.

22. The method as claimed in claim 15, wherein the master-side traffic manager and slave-side traffic manager use priority levels to form the groups of telegrams.

23. The method as claimed in claim 15, wherein a protocol is implemented to avoid collisions when transmitting telegrams so as to avoid collisions in the shared medium.

24. The method as claimed in claim 15, wherein the network comprises an industrial contact wire network.

25. A network arrangement for transmitting telegrams via a shared medium included in a network, the network arrangement comprising:
a control device;
a master level;
a shared medium;
a slave level; and
terminals;
wherein the control device, the master level, the shared medium, the slave level and the terminals each include at least one of (i) at least one master-side modem and (ii) at least one slave-side modem;
wherein the control device, the master level, the shared medium, the slave level and the terminals each include at least one of (i) at least one master-side traffic manager and (ii) at least one slave side traffic manager; and
wherein the network arrangement is configured to:
access the shared medium via each of at least one of the (i) at least one master-side modem and (ii) at least one slave-side modem;
perform communications between the control device and terminals via the shared medium; and
create availability of the telegrams by at least one of the (i) at least one master side traffic manager and (ii) at least one slave-side traffic manager to at least one of the (i) at least one master side modem and (ii) at least one slave-side modem; and
wherein at least one of the (i) at least one master-side traffic manager and (ii) at least one slave-side traffic manager has knowledge of structure of relevant parts of the network and compiles the telegrams into groups of telegrams.

26. The network arrangement as claimed in claim 25, wherein the shared medium comprises at least one of (i) a cable and (ii) line-bound medium with movable contacts.

27. The network arrangement as claimed in claim 26, wherein the cable and line-bound medium with movable contacts comprise contact wires.

28. A modem arrangement comprising:
at least one modem; and
a traffic manager;
wherein the modem arrangement is configured to:
access a shared medium via each of at least one of (i) at least one master-side modem and (ii) at least one slave-side modem;
perform communications between a control device and terminals via the shared medium; and
create availability of the telegrams by at least one of the (i) at least one master side traffic manager and (ii) at least one slave-side traffic manager to at least one of the (i) at least one master side modem and (ii) at least one slave-side modem; and
wherein at least one of the (i) at least one master-side traffic manager and (ii) at least one slave-side traffic manager has knowledge of structure of relevant parts of a network and compiles the telegrams into groups of telegrams.

29. The modem arrangement as claimed in claim 28, further comprising:
a modem manager.

30. An industrial conveying system having the network arrangement as claimed in claim 25.

31. The An industrial conveying system as claimed in claim 30, wherein the industrial conveying system comprises an electric monorail system.
